(19) United States
(12) Patent Application Publication
(10) Pub. No.: US 2007/0285593 A1
(43) Pub. Date: Dec. 13, 2007

(54) LIQUID CRYSTAL DISPLAY APPARATUS AND METHOD OF RESTORING DEFECTED PIXEL

(75) Inventor: Shinji Yamashita, Kumamoto (JP)

Correspondence Address: OBLON, SPIVAK, MCCLELLAND MAIER & NEUSTADT, P.C., 1940 DUKE STREET, ALEXANDRIA, VA, 22314, US

(73) Assignee: MITSUBISHI ELECTRIC CORPORATION, Chiyoda-ku (JP)

(21) Appl. No.: 11/743,308

(22) Filed: May 2, 2007

(30) Foreign Application Priority Data
May 19, 2006 (JP) JP2006-139664

(51) Int. Cl. G02F 1/136; G02F 1/13

(52) U.S. Cl. 349/47; 349/192

(57) ABSTRACT

The present invention relates to a liquid crystal display apparatus including a plurality of gate lines; a plurality of source lines formed so as to be substantially orthogonal to the gate lines; pixel electrodes formed in a matrix form at each intersecting part of the gate line and the source line; and a TFT, including a gate electrode connected to the gate line, a source electrode connected to the source line, and a drain electrode connected to the pixel electrode, formed in accordance with each pixel electrode. The TFT according to the present invention includes a hole in at least one of either the gate electrode or the drain electrode at a position where the gate electrode and the drain electrode overlap in plan view.

### BACKGROUND OF THE INVENTION

1. Field of the Invention

The present invention relates to a liquid crystal display apparatus and a method of restoring a defected pixel, in particular to a liquid crystal display apparatus in which the defected pixel caused by operation failure of thin film active elements can be restored, and a method of restoring the defected pixel.

2. Description of the Background Art

The method of manufacturing a liquid crystal display apparatus including a general thin film transistor (hereinafter referred to as TFT) is as follows. First, gate lines and gate electrodes are formed on a glass substrate (transparent insulating substrate), and an insulating film is formed thereon. An amorphous silicon (a-Si) film which is a semiconductor active film is formed on the insulating film. Source lines, source electrodes and drain electrodes are formed on the amorphous silicon film, an insulating film is stacked thereon, and pixel electrodes are ultimately formed. Contact holes are formed to electrically connect the drain electrodes and the pixel electrodes on the upper most layer. A counter substrate formed with a color filter and the like is manufactured apart from an array substrate manufactured through the above steps. The liquid crystal display apparatus is formed by laminating the array substrate and the counter substrate, injecting liquid crystal material and arranging driver circuit and the like.

If the TFT of the liquid crystal display apparatus formed as above has an operation failure, normal voltage is not applied to the pixel electrode, and a bright pixel defect is visually recognized. A case of N/W (normally white) in which light passes when voltage is not applied between the pixel electrode and the counter electrode is assumed for the liquid crystal display apparatus.

Conventionally, if the bright pixel defect caused by operation failure of TFT occurs, the method of restoring the defected pixel disclosed in Japanese Patent Application Laid-Open No. 5-210111 is performed. In the Japanese Patent Application Laid-Open No. 5-210111, the gate electrode and the drain line are connected using a laser repair device, and the gate voltage is applied to the pixel electrode connected to the drain electrode by way of the contact hole. The bright pixel defect caused by operation failure of the TFT is thereby indicated as dark pixel in the N/W liquid crystal display apparatus.

Since the visibility of a dark pixel defect is low compared to the bright pixel detect, the bright pixel defect is preferably indicated as dark pixel through repairing in terms of quality of the liquid crystal display apparatus, and the yield can also be enhanced.

### SUMMARY OF THE INVENTION

A method of irradiating laser light from the surface (front surface) formed with the TFT and a method of irradiating laser light from the back of the surface formed with the TFT, that is, the glass substrate side (back surface) are adopted when repairing to dark pixel described in Description of the Background Art. The repair from the front surface is possible if the presence of the operation failure of the TFT can be checked in the array substrate state. However, the repair to dark pixel is generally performed by checking the operation failure of the TFT with the array substrate and the counter substrate laminated. Thus, the repair performed after the array substrate and the counter substrate are laminated must inevitably be performed from the glass substrate side of the back surface due to the influence of light shielding film formed on the counter substrate.

However, since the gate electrode is formed on the lower most layer (layer closest to the glass substrate), the portion overlapping the drain electrode may not be visibly checked when performing the repair to dark pixel from the glass substrate side. Thus, the irradiating position of the laser light becomes the gate line rim at where the gate electrode and the drain electrode overlap. The length of the gate line rim has only a few locations to be irradiated with laser light since it is restricted by the width of the drain electrode. If the irradiating location is few, the connection may be disengaged, thereby returning to the bright pixel after the laser irradiation.

The irradiating energy must be intensified compared to when irradiating the laser light to the array substrate before lamination in order to connect the gate electrode and the drain electrode with the array substrate and the counter substrate laminated. If the irradiating energy of the laser light is intensified, the effect on the insulating film and the drain electrodes formed on the gate electrodes becomes significant in addition to forming a hole in the gate electrode. Specifically, the metal of the gate electrode may lift up due to the irradiating energy of the laser light, and the metal of the drain electrode may scatter as a block and float in the liquid crystal.

The cell gap (distance between the array substrate and the counter substrate) of when the array substrate and the counter substrate are laminated is about 4 μm. Thus, lifting of the electrically conductive metal and floating of electrically conductive metal block may cause short circuit between the pixel electrode etc. and the counter electrode, thereby causing bright pixel or line defect.

The present invention aims to provide a liquid crystal display apparatus in which the irradiating position of the laser light is clear, the gate electrode or the drain electrode has a shape capable of being reliably repaired, and lifting of the electrically conductive metal and scattering of the metal block can be suppressed, and a method of restoring the defected pixel.

The present invention relates to a liquid crystal display apparatus including a plurality of gate lines formed on a substrate; a plurality of source lines formed so as to be substantially orthogonal to the gate lines; pixel electrodes formed in a matrix form at each intersecting part of the gate line and the source line; and a thin film active element, including a gate electrode connected to the gate line, a source electrode connected to the source line, and a drain electrode connected to the pixel electrode, formed in accordance with each pixel electrode. The thin film active element includes a hole in at least one of either the gate electrode or the drain electrode at a position the gate electrode and the drain electrode overlap in plan view.

The irradiating position of the laser light is clear, repair can be reliably performed, and lifting of the electrically conductive metal and scattering of the metal block can be suppressed in the liquid crystal display apparatus according to the present invention since the thin film active element includes a hole in at least one of either the gate electrode or the drain electrode at the position the gate electrode and the drain electrode overlap in plan view.

The present invention relates to a liquid crystal display apparatus including a plurality of gate lines formed on a substrate; a plurality of source lines formed so as to be substantially orthogonal to the gate lines; pixel electrodes formed in a matrix form at each intersecting part of the gate line and the source line; and a thin film active element, including a gate electrode connected to the gate line, a source electrode connected to the source line, and a drain electrode connected to the pixel electrode, formed in accordance with each pixel electrode. The thin film active element includes at least one opening of horseshoe shape in at least one of either the gate electrode or the drain electrode at a position the gate electrode and the drain electrode overlap in plan view.

The irradiating position of the laser light is clear, repair can be reliably performed, and lifting of the electrically conductive metal or scattering of the metal block can be suppressed in the liquid crystal display apparatus according to the present invention since the thin film active element includes at least one opening of horseshoe shape in at least one of either the gate electrode or the drain electrode at a position the gate electrode and the drain electrode overlap in plan view.

These and other objects, features, aspects and advantages of the present invention will become more apparent from the following detailed description of the present invention when taken in conjunction with the accompanying drawings.

### BRIEF DESCRIPTION OF THE DRAWINGS

FIGS. 1A and 1B are plan view and cross sectional view, respectively, showing a liquid crystal display apparatus according to a first embodiment of the present invention;

FIG. 2 is an enlarged plan view showing a TFT of the liquid crystal display apparatus according to the first embodiment of the present invention;

FIG. 3 is an enlarged plan view showing a TFT of a liquid crystal display apparatus according to a second embodiment of the present invention;

FIG. 4 is an enlarged plan view showing a TFT of a liquid crystal display apparatus according to a fourth embodiment of the present invention; and

FIG. 5 is an enlarged plan view showing a TFT of a liquid crystal display apparatus according to a fifth embodiment of the present invention.

### DESCRIPTION OF THE PREFERRED EMBODIMENTS

### First Embodiment

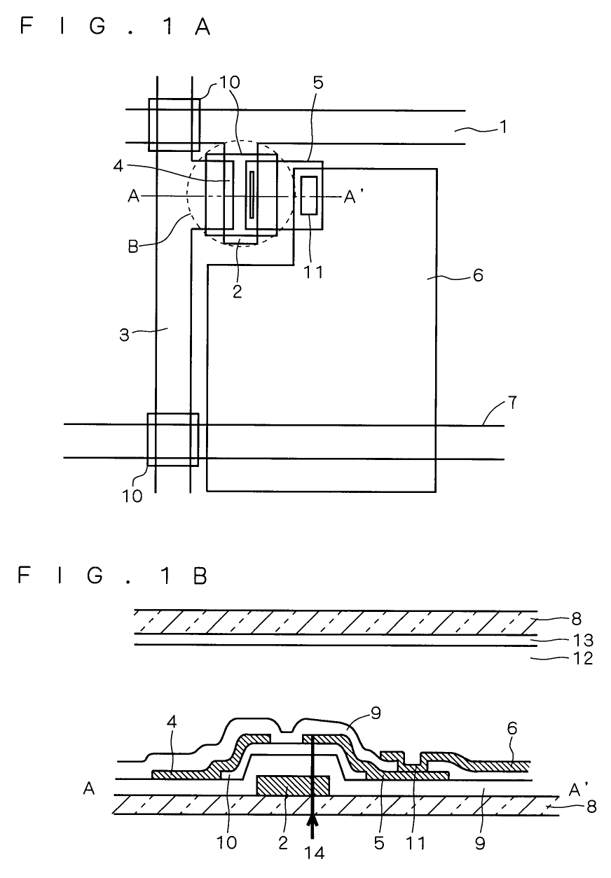

FIGS. 1A and 1B show plan view and cross sectional view, respectively, of a liquid crystal display apparatus according to the present embodiment. FIG. 1A shows a plan view of one pixel of the array substrate, and FIG. 1B shows a cross sectional view taken along line A-A′ of FIG. 1A. The liquid crystal display apparatus according to the present embodiment has a configuration in which the pixels are arranged in a matrix form, and each pixel is driven by a thin film transistor (TFT) which is a thin film active element.

The liquid crystal display apparatus according to the present embodiment has a gate line 1 and a gate electrode 2 arranged on a glass substrate 8 (transparent insulating substrate) as a first layer, an insulating film 9 arranged as a second layer, and an amorphous silicon (a-Si) film 10 which is a semiconductor active film arranged as a third layer, as shown in FIGS. 1A and 1B. The liquid crystal display apparatus according to the present embodiment further has a source line 3, a source electrode 4 and a drain electrode 5 arranged as a fourth layer, the insulating film 9 as a fifth layer, and finally a pixel electrode 11 as a sixth layer. A contact hole is formed in the insulating film 9 to electrically contact the drain electrode 5 and the pixel electrode 6.

A Cs (storage capacitor) line 7 is further arranged in the liquid crystal display apparatus according to the present embodiment, as shown in FIG. 1A. The Cs line 7 is formed in the same layer as the gate line 1 etc., and forms a storage capacitor between the pixel electrode 6. In FIG. 1A, the amorphous silicon film 10 is used to enhance the insulation at the intersecting part of the gate line 1 and the source line 3, and the intersecting part of the Cs line 7 and the source line 3.

The liquid crystal display apparatus according to the present embodiment further has a counter substrate arranged at the position opposing the array substrate formed with the TFT, as shown in FIG. 1B. The counter substrate has a counter electrode 13 arranged on the glass substrate 8. Although not shown, color filter, light shielding film and the like are sometimes arranged on the counter substrate. The liquid crystal material 12 is sandwiched by the array substrate and the counter substrate.

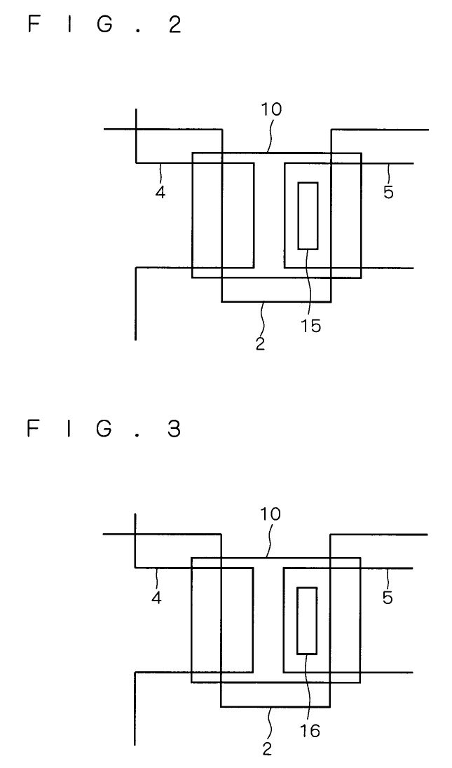

An enlarged view of region B of FIG. 1A is shown in FIG. 2. FIG. 2 shows an enlarged view of the TFT of the liquid crystal display apparatus according to the present embodiment. In FIG. 2, a hole 15 is formed in the gate electrode 2 at the position where the gate electrode 2 and the drain electrode 5 overlap in plan view. The hole 15 to be formed may be of any shape, and only needs to be at the position where the gate electrode 2 and the drain electrode 5 overlap in plan view.

The location of the hole 15 can be checked from the glass substrate side (back surface) by opening the hole 15 in the gate electrode 2. Thus, when the bright pixel defect caused by the operation failure of the TFT is produced and the repair to the dark pixel is to be performed, the laser light 14 is irradiated from the glass substrate side (back surface), as shown in FIG. 1B, and the gate electrode 2 and the drain electrode 5 are connected using the hole 15 of the gate electrode 2. That is, the laser light 14 is reliably irradiated to the overlapping portion of the gate electrode 2 and the drain electrode 5 by irradiating the laser light 14 to the peripheral edge of the hole 15 of the gate electrode 2.

Furthermore, the overlapping portion of the gate electrode 2 and the drain electrode 5 that can be recognized from the glass substrate side (back surface) and that can be irradiated with the laser light 14 is only one side of the gate electrode 2 in the prior art. However, the overlapping portion of the gate electrode 2 and the drain electrode 5 that can be recognized from the glass substrate side (back surface) and that can be irradiated with the laser light 14 increases to four sides of the peripheral edge of the hole 15 by forming the hole 15 in the gate electrode 2. Therefore, the location for connecting the gate electrode 2 and the drain electrode 5 increases by using the hole 15 of the gate electrode 2 in the liquid crystal display apparatus of the present embodiment.

In the liquid crystal display apparatus according to the present embodiment, the hole 15 is formed in the gate electrode 2, and the gate electrode 2 and the drain electrode 5 are connected at the peripheral edge of the hole 15, and thus the gate electrode 2 and the drain electrode 5 can be processed with an energy weaker than the energy of the conventional laser light used in connecting the gate electrode 2 and the drain electrode 5. The lifting of the metal of the drain electrode 5 and the scattering of the metal block can be thus reduced by using the laser light of weak energy in the liquid crystal display apparatus according to the present embodiment.

Therefore, the irradiating position of the laser light 14 is clear, repair can be reliably performed, and lifting of the electrically conductive metal or scattering of the metal block can be suppressed in the liquid crystal display apparatus according to the present embodiment since the hole 15 is formed in the gate electrode 2 at the position where the gate electrode 2 and the drain electrode 5 overlap in plan view.

The method of restoring the defected pixel of the liquid crystal display apparatus according to the present embodiment includes a step of specifying the defected pixel caused by operation failure of the TFT through lighting test etc., and a step of irradiating a predetermined laser light 14 to the peripheral edge of the hole 15 formed in the TFT of the specified defected pixel to connect the gate electrode 2 and the drain electrode 5, whereby lifting of the electrically conductive metal and scattering of the metal block can be suppressed and repair can be reliably performed.

One hole 15 is formed in the gate electrode 2 in the liquid crystal display apparatus according to the present embodiment, but the present invention is not limited thereto. The irradiating position of the laser light 14 can be checked from the glass substrate side (back surface), and repair can be reliably performed, similar to the present embodiment, even if a plurality of holes 15 are formed in the gate electrode 2 in a mesh form at the position where the gate electrode 2 and the drain electrode 5 overlap in plan view. Therefore, the present invention can have advantages of suppressing lifting of the electrically conductive metal and scattering of the metal block even if the plurality of holes 15 are formed in the same gate electrode 2.

### Second Embodiment

FIG. 3 shows an enlarged view of the TFT of the liquid crystal display apparatus according to the present embodiment. In FIG. 3, a hole 16 is formed in the drain electrode 5 at the position where the gate electrode 2 and the drain electrode 5 overlap in plan view. The hole 16 to be formed may be of any shape, and only needs to be at the position where the gate electrode 2 and the drain electrode 5 overlap in plan view. The hole 15 is not formed in the gate electrode 2 in the present embodiment.

In the present embodiment, the location of the hole 16 formed in the drain electrode 5 cannot be checked from the glass substrate side since the hole 15 is not formed in the gate electrode 2. Thus, the irradiating position of the laser light 14 cannot be specified using the hole 16 when the bright pixel defect caused by the operation failure of the TFT is produced and the laser light 14 is irradiated from the glass substrate side (back surface) as shown in FIG. 1B to connect the gate electrode 2 and the drain electrode 5.

However, scattering of the electrically conductive metal block can be suppressed since the hole 16 is formed in the drain electrode 5 in the present embodiment, compared to when irradiating the laser light 14 to connect the gate electrode 2 and the drain electrode 5 without forming the hole 16 in the drain electrode 5. That is, the amount of metal at the portion of connecting the gate electrode 2 and the drain electrode 5 can be reduced by forming the hole 16 in the drain electrode 5, and thus the amount of metal that scatters when the laser light 14 is irradiated can be suppressed in the liquid crystal display apparatus according to the present embodiment. Thus, the electrically conductive metal block produced when the laser light 14 is irradiated is prevented from becoming a size of a degree of short circuiting the pixel electrode 6 etc. and the counter electrode 13 in the present embodiment.

One hole 16 is formed in the drain electrode 5 in the liquid crystal display apparatus according to the present embodiment, but the present invention is not limited thereto. Effects similar to the present embodiment are obtained even if a plurality of holes 16 are formed in a mesh form in the drain electrode 5 at the position where the gate electrode 2 and the drain electrode 5 overlap in plan view.

### Third Embodiment

The hole 15 is formed in the gate electrode 2 at the position where the gate electrode 2 and the drain electrode 5 overlap in plan view in the liquid crystal display apparatus according to the first embodiment, as shown in FIG. 2. On the other hand, the hole 16 is formed in the drain electrode 5 at the position where the gate electrode 2 and the drain electrode 5 overlap in plan view in the liquid crystal display apparatus according to the second embodiment, as shown in FIG. 3.

First and second embodiments are combined in the liquid crystal display apparatus according to the present embodiment. That is, the hole 15 is formed in the gate electrode 2 at the position where the gate electrode 2 and the drain electrode 5 overlap in plan view, and the hole 16 is formed in the drain electrode 5 at the position where the gate electrode 2 and the drain electrode 5 overlap in plan view in the liquid crystal display apparatus of the present embodiment. The figure of the liquid crystal display apparatus according to the present embodiment is a combination of FIGS. 2 and 3, and thus the figure will be omitted.

Therefore, the irradiating position of the laser light is clear, repair can be reliably performed, and lifting of the electrically conductive metal and scattering of the metal block can be suppressed since the hole 15 is formed in the gate electrode 2 and the hole 16 is formed in the drain electrode 5 at the position where the gate electrode 2 and the drain electrode 5 overlap in plan view in the liquid crystal display apparatus according to the present embodiment.

The shape, position and size of the hole 15 and the hole 16 do not need to be the same in the liquid crystal display apparatus according to the present embodiment, and may be of different shape, position and size. The positions of the hole 15 and the hole 16 are limited, however, within the range the gate electrode 2 and the drain electrode 5 overlap in plan view.

One hole 15 is formed in the gate electrode 2 and one hole 16 is formed in the drain electrode 5 in the liquid crystal display apparatus according to the present embodiment, but the present invention is not limited thereto. Effects similar to the present embodiment are obtained even if a plurality of holes 16 are formed in mesh form in the gate electrode 2 and in the drain electrode 5 at positions where the gate electrode 2 and the drain electrode 5 overlap in plan view.

### Fourth Embodiment

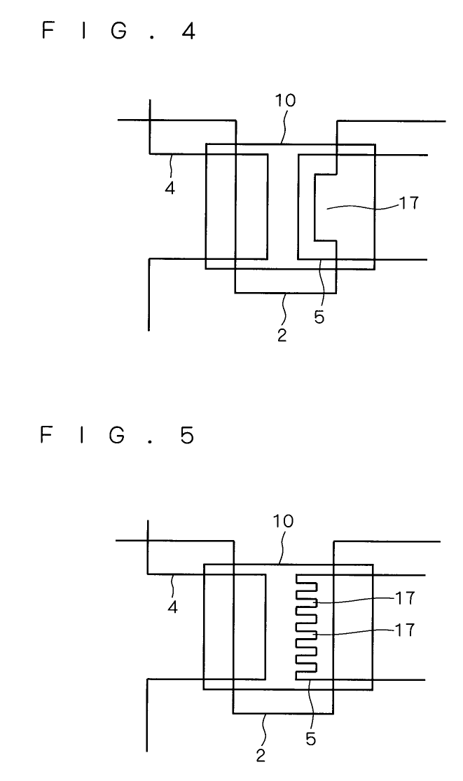

FIG. 4 shows an enlarged view of the TFT of the liquid crystal display apparatus according to the present embodiment. In FIG. 4, an opening 17 of a horseshoe shape is formed in the gate electrode 2 at the position where the gate electrode 2 and the drain electrode 5 overlap in plan view. The opening 17 to be formed may be of any size as long as it is formed at the position where the gate electrode 2 and the drain electrode 5 overlap in plan view.

The location of the opening 17 can be checked from the glass substrate side by forming the opening 17 in the gate electrode 2. Thus, the opening 17 of the gate electrode 2 can be used when bright pixel defect caused by operation failure of the TFT is produced, and the laser light 14 is irradiated from the glass substrate side (back surface), as shown in FIG. 1B to connect the gate electrode 2 and the drain electrode 5. That is, the laser light 14 can be reliably irradiated to the overlapping portion of the gate electrode 2 and the drain electrode 5 by irradiating the laser light 14 to the peripheral edge of the opening 17 of the gate electrode 2.

Only one side of the gate electrode 2 of the overlapping portion of the gate electrode 2 and the drain electrode 5 is the location of irradiating the laser light 14 in the prior art, but three sides of the peripheral edge of the opening 17 act as the locations of irradiating the laser light 14 by forming the opening 17. Thus, the location for connecting the gate electrode 2 and the drain electrode 5 increases by using the opening 17 of the gate electrode 2 in the liquid crystal display apparatus according to the present embodiment.

The opening 17 is formed in the gate electrode 2, and the gate electrode 2 and the drain electrode 5 are connected at the peripheral edge in the liquid crystal display apparatus according to the present embodiment, and thus the gate electrode 2 and the drain electrode 5 can be processed with an energy weaker than the energy of the conventional laser light used in connecting the gate electrode 2 and the drain electrode 5. Thus, lifting of the metal of the drain electrode 5 and scattering of the metal block can be reduced by using the laser light of weak energy in the liquid crystal display apparatus according to the present embodiment

In the example shown in FIG. 4, the opening 17 of horseshoe shape is formed in the gate electrode 2 at the position where the gate electrode 2 and the drain electrode 5 overlap in plan view, but the present invention is not limited thereto, and the opening of horseshoe shape may be formed in the drain electrode 5 or an opening of horseshoe shape may be formed in both the gate electrode 2 and the drain electrode 5 at the position where the gate electrode 2 and the drain electrode 5 overlap in plan view.

However, the irradiating position of the laser light 14 cannot be specified using the opening, but the amount of metal that scatters when the laser light 14 is irradiated can be suppressed when the opening of horseshoe shape is formed only in the drain electrode 5 at the position where the gate electrode 2 and the drain electrode 5 overlap in plan view.

Therefore, the irradiating position is clear, repair can be reliably performed, and lifting of the electrically conductive metal and scattering of the metal block can be suppressed since the opening of horseshoe shape is formed in at least one of the gate electrode or the drain electrode at the position where the gate electrode and the drain electrode overlap in plan view in the liquid crystal display apparatus according to the present embodiment.

### Fifth Embodiment

FIG. 5 shows an enlarged view of the TFT of the liquid crystal display apparatus according to the present embodiment. In FIG. 5, a plurality of openings 17 of horseshoe shape is formed in the drain electrode 5 at positions where the gate electrode 2 and the drain electrode 5 overlap in plan view. That is, the drain electrode 5 according to the present embodiment has a comb shape. The number and size of each opening 17 to be formed are not limited as long as it is formed at the position where the gate electrode 2 and the drain electrode 5 overlap in plan view.

When including the drain electrode 5 of a shape shown in FIG. 5, the opening 17 cannot be visibly recognized by the gate electrode 2 from the glass substrate side (back surface), and the irradiating position of the laser light 14 cannot be specified using the opening 17, but the amount of metal that scatters when the laser light 14 is irradiated can be suppressed.

Therefore, the metal of the drain electrode 5 that scatters when laser light 14 is irradiated can be smaller, and the production of defects caused by scattered metal can be prevented since a plurality of openings 17 are formed in the drain electrode 5 in the liquid crystal display apparatus according to the present embodiment.

In the example shown in FIG. 5, the opening 17 of horseshoe shape is formed in plurals in the drain electrode 5 at the position where the gate electrode 2 and the drain electrode 5 overlap in plan view, but the present invention is not limited thereto, and the opening of horseshoe shape may be formed in plurals in the gate electrode 2 at the position where the gate electrode 2 and the drain electrode 5 overlap in plan view, or the opening of horseshoe shape may be formed in plurals in both the gate electrode 2 and the drain electrode 5.

The location of the opening 17 can be checked from the glass substrate side if the opening of horseshoe shape is formed in plurals in the gate electrode 2 at the position where the gate electrode 2 and the drain electrode 5 overlap in plan view. Thus, the opening 17 of the gate electrode 2 can be used when bright pixel defect caused by operation failure of the TFT is produced, and the laser light 14 is irradiated from the glass substrate side (back surface) as shown in FIG. 1B to connect the gate electrode 2 and the drain electrode 5. That is, the laser light 14 can be reliably irradiated to the overlapping portion of the gate electrode 2 and the drain electrode 5 by irradiating the laser light 14 to the peripheral edge of the opening 17 of the gate electrode 2.

In the liquid crystal display apparatus according to the present invention, a hole or an opening shown in one of the first embodiment to the fifth embodiment can be combined to a configuration in which a hole or an opening is formed in the gate electrode 2 and the drain electrode 5 at the position where the gate electrode 2 and the drain electrode 5 overlap in plan view. For example, a combination in which the hole shown in the first embodiment is formed in the gate electrode 2 at the position where the gate electrode 2 and the drain electrode 5 overlap in plan view, and a plurality of openings shown in the fifth embodiment is formed in the drain electrode 5 at the position where the gate electrode 2 and the drain electrode 5 overlap in plan view is considered.

While the invention has been shown and described in detail, the foregoing description is in all aspects illustrative and not restrictive. It is therefore understood that numerous modifications and variations can be devised without departing from the scope of the invention.

What is claimed is:

1. A liquid crystal display apparatus comprising:
a plurality of gate lines formed on a substrate;
a plurality of source lines formed so as to be substantially orthogonal to said gate lines;
pixel electrodes formed in a matrix form at each intersecting part of said gate line and said source line; and
a thin film active element, including a gate electrode connected to said gate line, a source electrode connected to said source line, and a drain electrode connected to said pixel electrode, formed in accordance with each of said pixel electrode; wherein
said thin film active element includes a hole in at least one of either said gate electrode or said drain electrode at a position where said gate electrode and said drain electrode overlap in plan view.

2. The liquid crystal display apparatus according to claim 1, wherein said hole is formed in plurals in the same electrode.

3. A liquid crystal display apparatus comprising:
a plurality of gate lines formed on a substrate;
a plurality of source lines formed so as to be substantially orthogonal to said gate lines;
pixel electrodes formed in a matrix form at each intersecting part of said gate line and said source line; and
a thin film active element, including a gate electrode connected to said gate line, a source electrode connected to said source line, and a drain electrode connected to said pixel electrode, formed in accordance with each of said pixel electrode; wherein
said thin film active element includes at least one opening of horseshoe shape in at least one of either said gate electrode or said drain electrode at a position where said gate electrode and said drain electrode overlap in plan view.

4. The liquid crystal display apparatus according to claim 3, wherein said opening is formed in plurals in the same electrode.

5. A method of restoring a defected pixel of the liquid crystal display apparatus, said liquid crystal display apparatus comprising:
a plurality of gate lines formed on a substrate;
a plurality of source lines formed so as to be substantially orthogonal to said gate lines;
pixel electrodes formed in a matrix form at each intersecting part of said gate line and said source line; and
a thin film active element, including a gate electrode connected to said gate line, a source electrode connected to said source line, and a drain electrode connected to said pixel electrode, formed in accordance with each of said pixel electrode; wherein
said thin film active element includes a hole in at least one of either said gate electrode or said drain electrode at a position where said gate electrode and said drain electrode overlap in plan view,
said method comprising the steps of
specifying a defected pixel caused by operation failure of said thin film active element; and
irradiating a predetermined laser light to a peripheral edge of said hole formed in said thin film active element of said specified defected pixel to connect said gate electrode and said drain electrode.

6. A method of restoring a defected pixel of the liquid crystal display apparatus, said liquid crystal display apparatus comprising:
a plurality of gate lines formed on a substrate;
a plurality of source lines formed so as to be substantially orthogonal to said gate lines;
pixel electrodes formed in a matrix form at each intersecting part of said gate line and said source line; and
a thin film active element, including a gate electrode connected to said gate line, a source electrode connected to said source line, and a drain electrode connected to said pixel electrode, formed in accordance with each of said pixel electrode; wherein
said thin film active element includes a hole in at least one of either said gate electrode or said drain electrode at a position where said gate electrode and said drain electrode overlap in plan view,
said hole is formed in plurals in the same electrode,
said method comprising the step of:
specifying a defected pixel caused by operation failure of said thin film active element; and
irradiating a predetermined laser light to a peripheral edge of said hole formed in said thin film active element of said specified defected pixel to connect said gate electrode and said drain electrode.

7. A method of restoring a defected pixel of the liquid crystal display apparatus, said liquid crystal display apparatus comprising:
a plurality of gate lines formed on a substrate;
a plurality of source lines formed so as to be substantially orthogonal to said gate lines;
pixel electrodes formed in a matrix form at each intersecting part of said gate line and said source line; and
a thin film active element, including a gate electrode connected to said gate line, a source electrode connected to said source line, and a drain electrode connected to said pixel electrode, formed in accordance with each of said pixel electrode; wherein
said thin film active element includes a hole in at least one of either said gate electrode or said drain electrode at a position where said gate electrode and said drain electrode overlap in plan view,
said method comprising the steps of:
specifying a defected pixel caused by operation failure of said thin film active element; and
irradiating a predetermined laser light to a peripheral edge of said opening formed in said thin film active element of said specified defected pixel to connect said gate electrode and said drain electrode.

8. A method of restoring a defected pixel of the liquid crystal display apparatus, said liquid crystal display apparatus comprising:
a plurality of gate lines formed on a substrate;
a plurality of source lines formed so as to be substantially orthogonal to said gate lines;
pixel electrodes formed in a matrix form at each intersecting part of said gate line and said source line; and
a thin film active element, including a gate electrode connected to said gate line, a source electrode connected to said source line, and a drain electrode connected to said pixel electrode, formed in accordance with each of said pixel electrode; wherein
said thin film active element includes a hole in at least one of either said gate electrode or said drain electrode at a position where said gate electrode and said drain electrode overlap in plan view,
said opening is formed in plurals in the same electrode,
said method comprising the steps of:
specifying a defected pixel caused by operation failure of said thin film active element; and
irradiating a predetermined laser light to a peripheral edge of said opening formed in said thin film active element of said specified defected pixel to connect said gate electrode and said drain electrode.
